(19) United States
(12) Patent Application Publication
(10) Pub. No.: US 2008/0281751 A1
(43) Pub. Date: Nov. 13, 2008

(54) COLLATERAL REQUIREMENTS MATCHING AND DISPUTE RESOLUTION

(75) Inventors: Mark L. ROBINSON, New York, NY (US); Chaolun Harry Jin, West Windsor, NJ (US); Scott Linden, Belle Mead, NJ (US)

Correspondence Address: PILLSBURY WINTHROP SHAW PITTMAN, LLP, P.O. BOX 10500, MCLEAN, VA, 22102, US

(73) Assignee: The Bank of New York Company, Inc., New York, NY (US)

(21) Appl. No.: 11/747,040

(22) Filed: May 10, 2007

(51) Int. Cl. G06Q 40/00

(52) U.S. Cl. 705/38

(57) ABSTRACT

A collateral management method for a plurality of parties, each of the parties having a collateral requirement with at least one other party of the plurality of parties is disclosed, the method including matching the collateral requirements of the plurality of parties to determine a net collateral requirement of a party of the plurality of parties to one or more other parties of the plurality of parties, and making available for that party the net collateral requirement of that party.

### FIELD

This invention relates to financial collateral management.

### BACKGROUND

Financial collateral management is a significant part of a financial institution's framework for risk and regulatory compliance. It is fast becoming a business practice in its own right and is recognized as an important risk mitigating technique in the credit risk area, and part of the latest Basel II guidelines.

One mechanism to manage such collateral is a so-called tri-party collateral management system, such as Bank of New York's RepoEdge™ collateral management system. Designed to handle numerous asset types denominated in various currencies, such a system can process a wide array of transaction types, including tri-party repurchase agreements (both equity and fixed income), portfolio swaps, collateralized loans, and swap collateralization deals. Acting as a custodian, the collateral management system and its operator keep collateral in segregated accounts and mark-to-market daily to ensure that prescribed collateral margins are maintained. Working with both principal counterparties to a tri-party transaction, the system can automatically assess the eligibility of proposed collateral, provide multiple margins by security, and apply concentration limits. Further, the system can ensure that collateralization is maintained in accordance with pre-agreed eligibility criteria by controlling movements of collateral.

### SUMMARY

Nevertheless, due to the growing use of fully collateralized derivatives contracts and the operational complexity of collateral management, there is a need for an operationally efficient solution to management of the collateral requirements of parties. As used herein, a collateral requirement of a party includes a collateral obligation of the party to another party, or a right of the party to collateral from another party, or both.

According to an aspect of the invention, there is provided a computer program embodied in a tangible medium, the computer program comprising code configured to cause a computer to execute a collateral management method for a plurality of parties, each of the parties having a collateral requirement with at least one other party of the plurality of parties, the method comprising:

matching the collateral requirements of the plurality of parties to determine a net collateral requirement of a party of the plurality of parties to one or more other parties of the plurality of parties; and

making available for that party the net collateral requirement of that party.

According to an aspect of the invention, there is provided a collateral management method for a plurality of parties, each of the parties having a collateral requirement with at least one other party of the plurality of parties, the method comprising:

electronically matching the collateral requirements of the plurality of parties to determine a net collateral requirement of a party of the plurality of parties to one or more other parties of the plurality of parties; and

making available for that party the net collateral requirement of that party.

According to an aspect of the invention, there is provided a computer program embodied in a tangible medium, the computer program comprising code configured to cause a computer to execute a collateral management method for a plurality of parties, each of the parties having a collateral requirement with at least one other party of the plurality of parties, the method comprising:

performing a net of the collateral requirements of bilateral pairs of parties of the plurality of parties to determine a net collateral requirement of a party of the plurality of parties; and

making available for that party the net collateral requirement of that party.

According to an aspect of the invention, there is provided a computer program embodied in a tangible medium, the computer program comprising code configured to cause a computer to execute a collateral management method for a plurality of parties, each of the parties having a collateral requirement with at least one other party of the plurality of parties, the method comprising:

performing a net of the collateral requirements of the plurality of parties to determine a net collateral requirement of a party of the plurality of parties, the performing the net of the collateral requirements deemed to be performed simultaneously; and

making available for that party the net collateral requirement of that party.

According to additional aspects of the invention, the methods described above can be

### BRIEF DESCRIPTION OF THE DRAWINGS

Embodiments of the invention will now be described, by way of example only, with reference to the accompanying schematic drawings in which corresponding reference symbols indicate corresponding parts, and in which:

FIG. 1 is a state diagram of an example of the collateral requirements of a plurality of parties;

FIG. 2 is a process flow diagram of a collateral requirement matching and dispute resolution method according to an embodiment of the invention; and

FIG. 3 is a diagram showing schematically an example timing chart of a collateral requirement matching and dispute resolution method according to an embodiment of the invention.

### DETAILED DESCRIPTION

According to an embodiment of the invention, a collateral requirement matching and dispute resolution method (CRMDR) is provided. The CRMDR provides net collateral settlement and clearing for bilateral and/or multilateral collateral requirements among participating parties (e.g., banks, brokers and dealers), desirably on a timely basis with minimal disruption to existing workflows and practices by leveraging the existing legal and operational framework. One or more benefits of the CRMDR may include: collateral operations simplicity and efficiency, reduced operational and/or settlement risks, faster settlement of margin movement, less manual processing, less operational duplication, reduction of gross collateral requirements among participating parties, reduction of balance sheets by, for example, netting cash collateral posted/received against derivative payable/receivable (thus extending capital use for the participating parties), and reducing costs associated with settling collateral transactions arising from, for example, derivatives trading activities.

The CRMDR operates by extending the existing collateral arrangements between participating parties (e.g., banks, brokers, and dealers) to add a third party (e.g., a bank) to act as their collateral agent. The participating parties submit their daily collateral requirements with all other participating parties to the collateral agent. The CRMDR matches and nets the collateral requirements of the participating parties to enable one or more of the participating parties to post only their net collateral obligation to the other participating parties to the collateral agent. Participating parties that are net receivers of collateral will be collateralized via the CRMDR. The collateral agent may provide intra-settlement liquidity to the CRMDR, for long enough so that the process can close, so that all collateral requirements will be deemed to have settled simultaneously and for the full amount of the requirements. Thus, the difference between the net and gross collateral requirements will be deemed to have been posted in cash, preserving the balance sheet netting benefit of cash collateral. In an embodiment, the collateral agent does not take a principal position (and thus is not a counterpart), rather merely assuming an operational risk from the participating parties to the CRMDR.

The CRMDR is able to provide a de facto multilateral netting of collateral requirements while preserving the bilateral balance sheet net of the collateral requirements of each of the participating parties to the CRMDR. This is done by creating the artifice of sequential bilateral settlements. In comparison, the ability to net is lost in a multi-lateral netting arrangement with an essential counterparty in the middle due to the presence of a third party—the counterparty in the middle. In standard accounting practice, there must be only two parties to net a transaction. The counterparty in the middle prevents the balance sheet netting of the collateral requirements of the parties. Further, the concern of kiting may be avoided by deeming the bilateral settlements to be simultaneous.

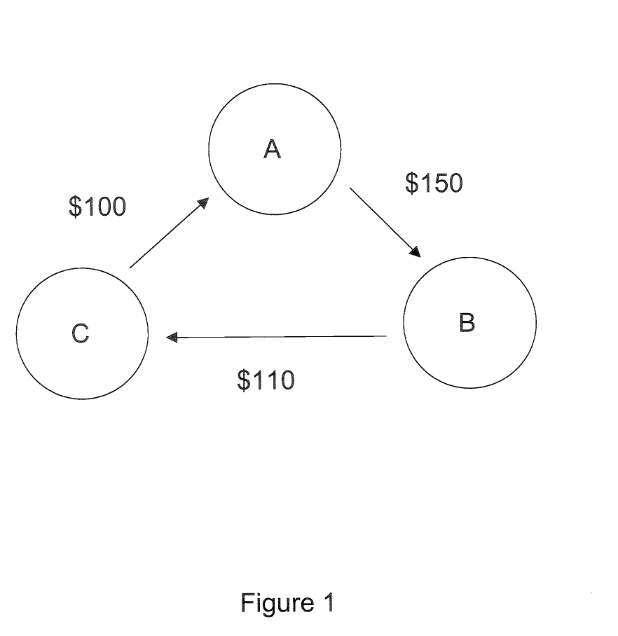

Referring to FIG. 1, a basic example of the collateral requirements of participating parties to the CRMDR is illustrated as well as the matching and netting of the CRMDR is described. Assume as an example that there are only three participating parties to the CRMDR—firms A, B, and C, where A owes $150 in collateral to B, B owes $110 in collateral to C, and C owes $100 in collateral to A. A would therefore have a net collateral obligation of $50 (and deliver that $50 in collateral) to the CRMDR, i.e., the collateral agent of the CRMDR. B and C, because they are owed collateral, would be collateralized by means of re-hypothecation of collateral through the CRMDR and related advances by the collateral agent.

In an embodiment, the settlement process matches requirements of bilateral pairs of participating parties and proceeds in a sequential fashion with an initial transfer of $150 in collateral from A's account to B's account, with a resulting overdraft of $100 in A's collateral account with the collateral agent. B marks its books as paid in full because $100 is in cash (which is desirable to B because B gets the net, the cash, against the transaction receivable on B's balance sheet resulting in B preserving its balance sheet netting). B would re-hypothecate $110 in collateral to C (with $40 in collateral remaining in B's account) and C would in turn re-hypothecate $100 in collateral to A (with $10 in collateral remaining in C's account). The $100 in collateral transferred by C to A would be applied immediately to satisfy the overdraft in A's collateral account.

So, as a practical example, consider the collateral position of any of the major banks or derivatives dealers. They are either long or short collateral to most, if not all, of each of other, and try to maximize the use of their collateral by re-hypothecating collateral whenever possible. While most firms would prefer to use securities as collateral, operational headaches and different collateral eligibility schedules (e.g., the varying ability to use certain intangibles as collateral) limit the utilization of securities to an estimated less than 25% of the $1.33 trillion in collateral in use (ISDA Margin Survey 2006). In addition, United States accounting practices currently allow a pledgor/secured party of cash collateral to net that position against the balance sheet deliverable/receivable. As a result, a firm may have, for example, $12 billion in collateral pledged, $11.5 billion in collateral received in total from other parties (some in securities, most in cash), and the full operational headache of managing $23.5 billion in collateral. Thus, the CRMDR can allow a firm to satisfy its collateral requirements against all other participating members as a single net requirement. Using the previous figures, the firm would make a single delivery of $500 million of eligible collateral to the CRMDR to satisfy all of its requirements. In turn, the firm would also be fully collateralized by all of its counterparties in the CRMDR.

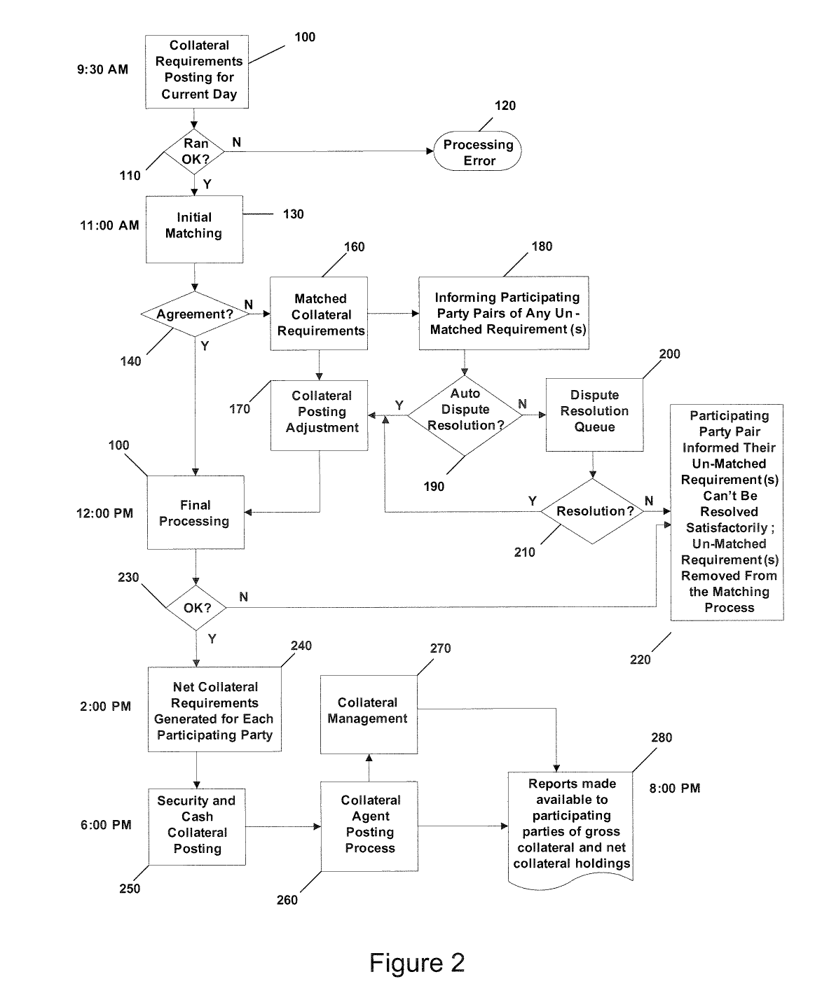

Referring to FIG. 2, an example flow chart of the CRMDR method according to an embodiment of the invention is depicted along with example timing during a day of the CRMDR steps. At step 100 in FIG. 2, each of the participating parties to the CRMDR make available to the CRMDR their collateral requirements with the other CRMDR parties. In an embodiment, the parties may submit, and/or allow to be retrieved, their collateral requirements, for example, via file transfer, software application interface (API) and/or manual input via a World Wide Web application. This may occur at certain hours of the day, e.g., 9:30 AM to 11:00 AM after the parties have marked their books based on the previous closed marked, and may occur daily. In an embodiment, each party to the CRMDR has a collateral account with the collateral agent for the CRMDR that will be used for purposes of collateral deliveries and receipts under the CRMDR. In an embodiment, the participating parties to the CRMDR may submit all their collateral requirements with the participating parties or may submit less than all their collateral requirements (e.g., only cash collateral requirements).

At step 110, the CRMDR checks whether the collateral requirements posting of the participating parties has performed properly and if not, a processing error 120 is signaled. If the posting has performed properly, initial matching of collateral requirements is performed at step 130.

At step 130, the collateral agent conducts a first level of matching/reconciliation of collateral requirements among the participating parties to the CRMDR. The collateral agent matches collateral requirements among all bilateral pairs of the participating parties to the CRMDR. If there is agreement on matching at step 140 of the collateral requirements among the bilateral pairs (e.g., all collateral requirement amounts are agreed to among the participating parties), final reconciliation of the collateral requirements is performed at step 150. In an embodiment, the matching is done of the value amounts of the collateral requirements, with or without account of the types of collateral. Where the types of collateral are accounted for, the value amounts may be adjusted, for example, using a valuation percentage depending on the type of collateral as discussed further below or separate matching may be performed for each of different types of collateral.

If there isn't agreement in the matching of one or more of the collateral requirements of the participating parties, a dispute resolution process is started at step 160. As an example of lack of agreement on matching, a party may specify that the amount of collateral owed to another party is, e.g., $105 and that other party specifies that the amount owed is, e.g., $100. Such a dispute may come about because the parties disagree as to the value of the collateral. Another way such a dispute may come about is from trade capture. For example, one party specifies that a certain trade occurred for which collateral is owed (or no longer owed) and the other specifies that such a trade didn't occur. The inconsistency may arise, for example, from a time lag in a trade hitting the systems of the parties.

So, at step 160, the one or more matched collateral requirements of one or more pairs of participating parties are determined, e.g., those amounts of collateral requirements of pairs of participating parties that do match are identified. In the previous example, that would be $100 of the collateral with $5 disputed. The matched collateral requirement(s) of the pair(s) of participating parties (e.g., the $100 in the previous example) is kept as part of the final reconciliation at step 150 through a collateral posting adjustment at step 170. The collateral requirement(s) of the pair(s) of participating parties that do not match is identified, e.g., those amounts of collateral requirements of pairs of participating parties that don't match, and the participating party pair(s) is informed of any un-matched collateral requirement(s) at step 180.

The unmatched collateral requirement(s) (e.g., the $5 in the previous example) is submitted to an automatic dispute resolution mechanism 190 and if so resolved, the resolved un-matched collateral requirement(s) is now matched and kept as part of the final reconciliation at step 150 through a collateral posting adjustment at step 170. In an embodiment, the automatic dispute resolution process comprises automatic determination by a suitably programmed computer of whether the collateral requirement(s) can be matched by, e.g., evaluating electronic data associated with the participating parties of the un-matched collateral requirement(s) such as underlying trade information, collateral valuation and particulars, etc. In an embodiment, the dispute resolution process may comprise automatically splitting a disputed amount if within a range of tolerance. So, using the previous example, if the tolerance is $10 (that is the disputed amount must be less than $10 to be resolved with this process), the disputed $5 amount may be split such that $2.50 is considered matched and kept as part of the final reconciliation and the other $2.50 is submitted to the dispute resolution queue as discussed below. If not within the range of tolerance, the disputed amount is otherwise resolved through, for example, the dispute resolution queue described below.

If the unmatched collateral requirement(s) can not be resolved through, for example, the auto-dispute resolution mechanism at step 170, the un-matched collateral requirement(s) may be added to a dispute resolution queue at step 200. Through the dispute resolution queue at step 200, the un-matched collateral requirement(s) may be resolved, for example, manually by the collateral agent contacting the participating parties of the un-matched collateral requirement(s) to resolve the dispute or the participating parties of the unmatched collateral requirement(s) contacting each other to resolve the dispute and notifying the collateral agent. For example, the participating parties of the unmatched collateral requirement(s) could review the associated transactions (trades) with the unmatched collateral requirement(s) to determine the agreed to amount of the collateral requirement through, for example, determining the value of the underlying transaction and/or reconciling the number and specifics of the underlying transactions.

If the dispute regarding the un-matched collateral requirement(s) can be resolved at step 210, the resolved un-matched collateral requirement(s) is now matched and kept as part of the final reconciliation at step 150 through a collateral posting adjustment at step 170. In an embodiment, a time limit may be imposed on the dispute resolution queue at step 200 so that all matched collateral requirements can be processed at the final processing at step 150 and the un-matched collateral requirement(s) in the dispute resolution queue is removed from the matching process.

If the un-matched collateral requirement(s) can not be resolved through the dispute resolution queue at step 200, the participating party pair is informed that their disputed collateral requirement(s) can't be resolved satisfactorily. The disputed collateral requirement(s) is removed from the matching process.

At step 150, final matching/reconciliation of collateral requirements among the participating parties is performed by the collateral agent, including of already matched collateral requirements and of any collateral requirement(s) kept after dispute resolution. In particular, for example, the collateral agent performs final matching of collateral requirements among all bilateral pairs of the participating parties to the CRMDR. At step 230, a check is performed to determine whether the collateral requirements properly match. If there isn't proper matching, any unmatched collateral requirement(s) is removed from the matching process and the participating party pair of the un-matched collateral requirement(s) is informed that their unmatched collateral requirement(s) can't be resolved satisfactorily and is removed from processing.

With processing complete at step 150, i.e., all collateral requirements remaining in the CRMDR of the participating party pair having been matched, each participating party will receive a confirmation notice at step 240 from the collateral agent specifying the party's net collateral position within the CRMDR. Thus, each party would receive a report from the CRMDR showing that it is fully collateralized by all of its counterparties within the CRMDR and indicating its net collateral obligation to the participating parties, if any. In an embodiment, the report may provide the net collateral obligation owed to the participating party from one or more of the other participating parties, if any. In an embodiment, the notice may provide each party's previous and new net collateral position and/or the party's gross collateral position in the CRMDR.

At step 250, one or more parties to the CRMDR post security and cash collateral to the collateral agent for each of their net collateral obligations to the participating parties after the collateral requirements matching. At step 260, the collateral agent performs its own posting process of collateral receipts and participating party collateral accounts. As part of the processing, the collateral agent may employ a collateral management engine 270 (such as Bank of New York's RepoEdge system) to provide cash and collateral accounting. The collateral management engine can verify collateral eligibility and mark to market the value of the collateral using issuer ratings and other pricing data from market data vendors. Finally, at step 280, reports may be made available to the participating parties of their gross and net collateral holdings in their accounts with the collateral agent.

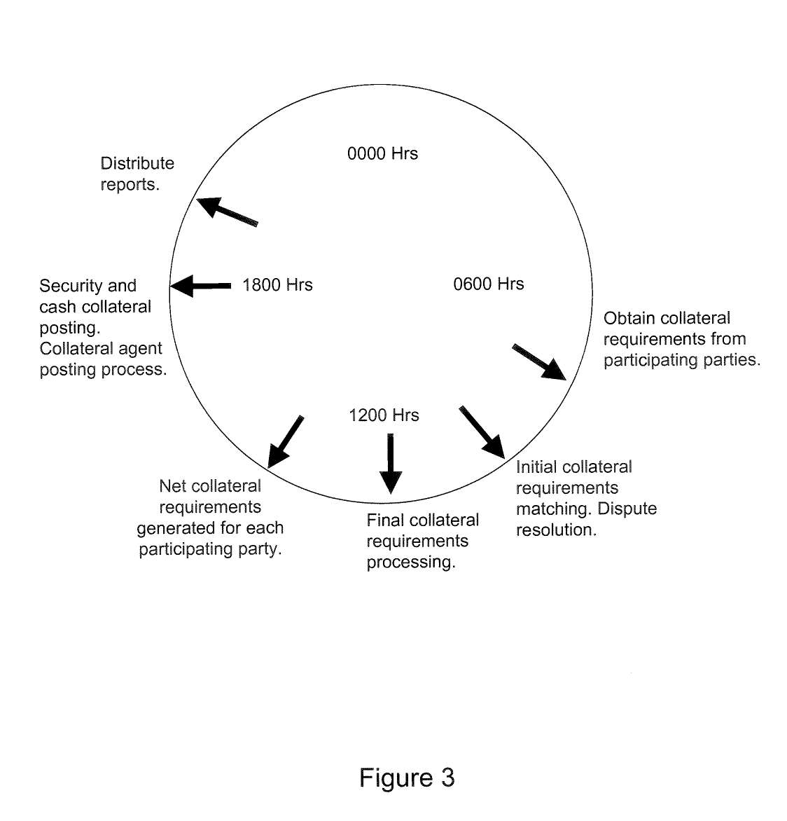

Referring to FIG. 3, an example timing chart of a collateral requirement matching and dispute resolution method according to an embodiment of the invention is shown. At about 9:30 AM to 11:00 AM, each of the participating parties to the CRMDR make available to the CRMDR their collateral requirements with the other CRMDR parties. From 11:00 AM to 12:00 PM, initial collateral requirements matching is performed along with the optional dispute resolution of unmatched collateral requirements. Following the initial matching and, if applicable, dispute resolution, final collateral requirements processing is completed between 12:00 PM and 2:00 PM. Around 2:00 PM, the net collateral requirements are generated and reported for each participating party. From 6:00 PM to 8:00 PM, each participating party with a net collateral obligation to one or more of the other participating parties posts security and cash collateral for that net collateral obligation. Further, the collateral agent posting process is completed during that period and reports may be made available to the participating parties of their gross and net collateral holdings in their accounts with the collateral agent.

In an embodiment, all of the transactions within the CRMDR settlement process are, under the CRMDR legal documents, deemed to have happened simultaneously, the end result of which is that all of the parties to the CRMDR are fully collateralized and will have maximized their reuse of the collateral posted to them.

In an embodiment, collateralization through the CRMDR will be a next day process, but should the parties to the CRMDR agree to it, same day collateralization may be supported. After the receipt of new collateral from those parties to the CRMDR whose deficit has increased, the collateral agent will initiate the settlement process, send confirmation of settlement to the parties, and return collateral to those parties whose deficit has decreased.

In an embodiment, all parties to CRMDR are banks or swap dealers, and/or meet the eligibility requirements specified in the CRMDR legal documents. These requirements may include minimum capitalization, minimum credit rating or other criteria.

In an embodiment, the CRMDR will operate via an amendment to existing bilateral collateral legal documents between participating parties and optionally a separate CRMDR legal agreement. The amendment will appoint the collateral agent as custodian for the parties, and specify that any collateral posted to the CRMDR will conform to CRMDR requirements, not those of the existing collateral legal documents. The amendment, and/or optionally the separate CRMDR legal agreement, will set procedures for matching collateral requirements, timeframes for the delivery of collateral, specify collateral eligibility, create the simultaneous receipt and delivery of collateral, set the fees for participating parties and specify other CRMDR details. In an embodiment, the participating parties will elect four or five representatives to a CRMDR steering board, which will serve as a forum for CRMDR rule changes such as cut-off times, membership criteria and eligible collateral.

In an embodiment, the CRMDR nets down the movement of the collateral associated with the exposures related to underlying derivative transactions of the participating parties to CRMDR.

In an embodiment, eligible collateral includes the following items with the example valuation percentage as collateral in the CRMDR:

| | Valuation |
|---|---|
| Collateral | Percentage |
| Cash (U.S. dollars) | 100% |
| U.S. Treasury obligations with remaining maturity of not | 99.5% |
| more than 1 year | |
| U.S. Treasury obligations with remaining maturity of more | 98% |
| than 1 year but not more than 10 years | |
| U.S. Treasury obligations with remaining maturity of not | 95% |
| more than 10 years | |
| U.S. government agency or GSE debt with remaining | 90% |
| maturity of not more than 10 years | |
| Single class mortgage participation, pass-through or fully | 90% |
| modified pass-through certificates guaranteed by FHLMC, | |
| FNMA or GNMA | |

In an embodiment, wherever cash collateral is used (including cash derived from an overdraft in the party's collateral account), that party to the CRMDR would continue to receive the netting benefit of cash collateral.

In an embodiment, audit/review services or procedures may be provided to provide comfort to the parties to the CRMDR that their collateral accounts will be operated properly.

In an embodiment, the CRMDR may be implemented in a tri-party collateral management mechanism, such as Bank of New York's RepoEdge system, because such a mechanism has a matching engine, has the ability to receive and deliver collateral through electronic links, has the ability to value collateral, and is able to automatically filter collateral against certain eligibility requirements.

One or more of the embodiments of the invention may be implemented as apparent to those skilled in the art in hardware or software, or any combination thereof. The actual software code or specialized hardware used to implement an embodiment of the invention is not limiting of the invention. Thus, the operation and behavior of the embodiments often will be described without specific reference to the actual software code or specialized hardware components. The absence of such specific references is feasible because it is clearly understood that artisans of ordinary skill would be able to design software and hardware to implement the embodiments of the invention based on the description herein with only a reasonable effort and without undue experimentation. For example, a software database system with an appropriate software front-end (e.g., SQL scripts and calculation methods) may be implemented to practice the CRMDR.

A procedure is here, and generally, conceived to be a self-consistent sequence of steps leading to a desired result. These steps are those requiring physical manipulations of physical quantities. Usually, though not necessarily, these quantities take the form of electrical or magnetic signals capable of being stored, transferred, combined, compared, and otherwise manipulated. It proves convenient at times, principally for reasons of common usage, to refer to these signals as bits, values, elements, symbols, characters, terms, numbers, objects, attributes or the like. It should be noted, however, that all of these and similar terms are to be associated with the appropriate physical quantities and are merely convenient labels applied to these quantities.

Further, the manipulations performed are often referred to in terms, such as adding or comparing, which are commonly associated with mental operations performed by a human operator. No such capability of a human operator is necessary, or desirable in most cases, in any of the operations described herein. Useful machines for performing operations of one or more embodiments of the invention include general purpose digital computers or similar devices.

Each step of the method may be executed on any general computer, such as a mainframe computer, personal computer or the like and pursuant to one or more, or a part of one or more, program modules or objects generated from any programming language, such as C#, C++, Java, Fortran or the like. And still further, each step, or a file or object or the like implementing each step, may be executed by special purpose hardware or a circuit module designed for that purpose. For example, an embodiment of the invention may be implemented as a firmware program loaded into non-volatile data storage medium or a software program loaded from or into a data storage medium as machine-readable code, such code being instructions executable by an array of logic elements such as a microprocessor or other digital signal processing unit.

In the case of diagrams depicted herein, they are provided by way of example. There may be variations to these diagrams or the steps (or operations) described herein without departing from the spirit of the invention. For instance, in certain cases, the steps may be performed in differing order, or steps may be added, deleted or modified. All of these variations are considered to comprise part of the invention as recited in the appended claims.

An embodiment of the invention may desirably be implemented in a high level procedural or object-oriented programming language to communicate with a computer. However, an embodiment of the invention may be implemented in assembly or machine language, if desired. In any case, the language may be a compiled or interpreted language.

An embodiment of the invention may be implemented as an article of manufacture comprising a computer usable medium having computer readable program code means therein for executing the method steps of the invention, a program storage device readable by a machine, tangibly embodying a program of instructions executable by a machine to perform the method steps of an embodiment of the invention, or a computer program product, or an article of manufacture comprising a computer usable medium having computer readable program code means therein, the computer readable program code means in said computer program product comprising computer readable code means for causing a computer to execute the steps of the invention or a computer readable medium encoded with a set of executable instructions to perform the method steps of an embodiment of the invention. Such an article of manufacture, or computer program product, or computer usable medium may include, but is not limited to, CD-ROMs, diskettes, tapes, hard drives, computer system memory (e.g. RAM or ROM) and/or the electronic, magnetic, optical, biological or other similar embodiment of the program (including, but not limited to, a carrier wave modulated, or otherwise manipulated, to convey instructions that can be read, demodulated/decoded and executed by a computer). Indeed, the article of manufacture, or computer program product, or computer usable medium may include any solid or fluid transmission medium, magnetic or optical, or the like, for storing or transmitting signals readable by a machine for controlling the operation of a general or special purpose computer according to the method of an embodiment of the invention and/or to structure its components in accordance with a system of an embodiment of the invention.

An embodiment of the invention may also be implemented in a system. A system may comprise a computer that includes a processor and a memory device and optionally, a storage device, an output device such as a video display and/or an input device such as a keyboard or computer mouse. Moreover, a system may comprise an interconnected network of computers. Computers may equally be in stand-alone form (such as the traditional desktop personal computer) or integrated into another apparatus (such a cellular telephone).

The system may be specially constructed for the required purposes to perform, for example, the method steps of an embodiment of the invention or it may comprise one or more general purpose computers as selectively activated or reconfigured by a computer program in accordance with the teachings herein stored in the computer(s). The system could also be implemented in whole or in part as a hard-wired circuit or as a circuit configuration fabricated into an application-specific integrated circuit. The invention presented herein is not inherently related to a particular computer system or other apparatus. The required structure for a variety of these systems will appear from the description given.

While this invention has been described in relation to one or more embodiments, it will be understood by those skilled in the art that other embodiments according to the generic principles disclosed herein, modifications to the disclosed embodiments and changes in the details of construction, arrangement of parts, compositions, processes, structures and materials selection all may be made without departing from the spirit and scope of the invention. Many modifications and variations are possible in light of the above teaching. Thus, it should be understood that the above described embodiments have been provided by way of example rather than as a limitation of the invention and that the specification and drawing(s) are, accordingly, to be regarded in an illustrative rather than a restrictive sense. As such, the present invention is not intended to be limited to the embodiments shown above but rather is to be accorded the widest scope consistent with the principles and novel features disclosed in any fashion herein.

1. A computer program embodied in a tangible medium, the computer program comprising code configured to cause a computer to execute a collateral management method for a plurality of parties, each of the parties having a collateral requirement with at least one other party of the plurality of parties, the method comprising:
matching the collateral requirements of the plurality of parties to determine a net collateral requirement of a party of the plurality of parties to one or more other parties of the plurality of parties; and
making available for that party the net collateral requirement of that party.

2. The computer program of claim 1, wherein matching the collateral requirements comprises performing a net of the collateral requirements of bilateral pairs of parties of the plurality of parties.

3. The computer program of claim 2, wherein matching the collateral requirements is deemed to be performed simultaneously.

4. The computer program of claim 2, wherein performing the net of the collateral requirements of bilateral pairs is performed in a sequential fashion.

5. The computer program of claim 1, wherein matching the collateral requirements is deemed to be performed simultaneously.

6. The computer program of claim 1, wherein the method further comprises obtaining amounts of the collateral requirements and identification of the plurality of parties of the collateral requirements.

7. The computer program of claim 1, wherein the method further comprises identifying any disputed amount of the collateral requirements and automatically splitting the disputed amount if within a range of tolerance.

8. The computer program of claim 7, wherein the method further comprises resolving the disputed amount if not within the range of tolerance.

9. The computer program of claim 1, the method further comprising identifying any disputed amount of the collateral requirements and resolving the disputed amount.

10. The computer program of claim 9, comprising resolving the disputed amount using an automatic dispute resolution process.

11. A collateral management method for a plurality of parties, each of the parties having a collateral requirement with at least one other party of the plurality of parties, the method comprising:
electronically matching the collateral requirements of the plurality of parties to determine a net collateral requirement of a party of the plurality of parties to one or more other parties of the plurality of parties; and
making available for that party the net collateral requirement of that party.

12. The method of claim 11, wherein matching the collateral requirements comprises performing a net of the collateral requirements of bilateral pairs of parties of the plurality of parties.

13. The method of claim 12, wherein matching the collateral requirements is deemed to be performed simultaneously.

14. The method of claim 12, wherein performing the net of the collateral requirements of bilateral pairs is performed in a sequential fashion.

15. The method of claim 11, wherein matching the collateral requirements is deemed to be performed simultaneously.

16. The method of claim 11, further comprising obtaining amounts of the collateral requirements and identification of the plurality of parties of the collateral requirements.

17. The method of claim 11, further comprising identifying any disputed amount of the collateral requirements and automatically splitting the disputed amount if within a range of tolerance.

18. The method of claim 17, further comprising resolving the disputed amount if not within the range of tolerance.

19. The method of claim 11, further comprising identifying any disputed amount of the collateral requirements and resolving the disputed amount.

20. The method of claim 19, comprising resolving the disputed amount using an automatic dispute resolution process.

21. A computer program embodied in a tangible medium, the computer program comprising code configured to cause a computer to execute a collateral management method for a plurality of parties, each of the parties having a collateral requirement with at least one other party of the plurality of parties, the method comprising:
performing a net of the collateral requirements of bilateral pairs of parties of the plurality of parties to determine a net collateral requirement of a party of the plurality of parties; and
making available for that party the net collateral requirement of that party.

22. The computer program of claim 21, wherein performing the net of the collateral requirements is deemed to be performed simultaneously.

23. The computer program of claim 21, wherein performing the net of the collateral requirements of bilateral pairs is performed in a sequential fashion.

24. The computer program of claim 21, wherein the method further comprises identifying any disputed amount of the collateral requirements and resolving the disputed amount.

25. The computer program of claim 24, comprising resolving the disputed amount using an automatic dispute resolution process.

26. A computer program embodied in a tangible medium, the computer program comprising code configured to cause a computer to execute a collateral management method for a plurality of parties, each of the parties having a collateral requirement with at least one other party of the plurality of parties, the method comprising:
performing a net of the collateral requirements of the plurality of parties to determine a net collateral requirement of a party of the plurality of parties, the performing the net of the collateral requirements deemed to be performed simultaneously; and
making available for that party the net collateral requirement of that party.

27. The computer program of claim 26, wherein the method further comprises identifying any disputed amount of the collateral requirements and resolving the disputed amount.

28. The computer program of claim 27, comprising resolving the disputed amount using an automatic dispute resolution process.

29. A collateral management method for a plurality of parties, each of the parties having a collateral requirement with at least one other party of the plurality of parties, the method comprising:
matching the collateral requirements of the plurality of parties to determine a net collateral requirement of a party of the plurality of parties to one or more other parties of the plurality of parties; and
making available for that party the net collateral requirement of that party.

30. The method of claim 29, wherein matching the collateral requirements comprises performing a net of the collateral requirements of bilateral pairs of parties of the plurality of parties.

31. The method of claim 30, wherein matching the collateral requirements is deemed to be performed simultaneously.

32. The method of claim 30, wherein performing the net of the collateral requirements of bilateral pairs is performed in a sequential fashion.

33. The method of claim 29, wherein matching the collateral requirements is deemed to be performed simultaneously.

34. The method of claim 29, wherein the method further comprises obtaining amounts of the collateral requirements and identification of the plurality of parties of the collateral requirements.

35. The method of claim 29, wherein the method further comprises identifying any disputed amount of the collateral requirements and automatically splitting the disputed amount if within a range of tolerance.

36. The method of claim 35, wherein the method further comprises resolving the disputed amount if not within the range of tolerance.

37. The method of claim 29, the method further comprising identifying any disputed amount of the collateral requirements and resolving the disputed amount.

38. A collateral management method for a plurality of parties, each of the parties having a collateral requirement with at least one other party of the plurality of parties, the method comprising:
performing a net of the collateral requirements of bilateral pairs of parties of the plurality of parties to determine a net collateral requirement of a party of the plurality of parties; and
making available for that party the net collateral requirement of that party.

39. The method of claim 38, wherein performing the net of the collateral requirements is deemed to be performed simultaneously.

40. The method of claim 38, wherein performing the net of the collateral requirements of bilateral pairs is performed in a sequential fashion.

41. The method of claim 38, wherein the method further comprises identifying any disputed amount of the collateral requirements and resolving the disputed amount.

42. The method of claim 41, comprising resolving the disputed amount using an automatic dispute resolution process.
